(19) United States
(12) Patent Application Publication
(10) Pub. No.: US 2013/0325639 A1
(43) Pub. Date: Dec. 5, 2013

(54) System and Method for Aggregating and Distributing Media Content

(71) Applicant: Matthew McCullough, Del Rey, CA (US)

(72) Inventor: Matthew McCullough, Del Rey, CA (US)

(21) Appl. No.: 13/891,828

(22) Filed: May 10, 2013

Related U.S. Application Data
(60) Provisional application No. 61/645,314, filed on May 10, 2012.

(51) Int. Cl. G06Q 30/02

(52) U.S. Cl. CPC G06Q 30/0277
USPC 705/14.73

(57) ABSTRACT

The present invention provides an engine, system and method media and data access between alternative platform systems and devices having access to the present invention. The present invention may be immediately deployable within an existing technology infrastructure, and may be deployed as a thin client and/or user-transparent client, and may further provide for cross-platform communication between systems and devices not otherwise communicatively compatible.

### CROSS REFERENCE TO RELATED APPLICATIONS

The present invention claims priority to U.S. Provisional Patent No. 61/645314, filed May 10, 2012, entitled System and Method For Aggregating and Distributing Media Content, the entire disclosure of which is incorporated by reference herein.

### FIELD OF THE INVENTION

The present invention relates to data management in relation to information access and sharing across platforms, and, more particularly, to an engine, system and method of aggregating and distributing media content.

### SUMMARY

The present invention relates to data management in relation to information access and sharing across platforms, and, more particularly, to an engine, system and method of aggregating and distributing media content.

### BRIEF DESCRIPTION OF THE DRAWINGS

The accompanying drawings are included to provide a further understanding of the disclosed embodiments. In the drawings:

FIG. 1 is a block diagram of an exemplary computing system for use in accordance with herein described systems and methods;

FIG. 2 is a block diagram showing an exemplary networked computing environment for use in accordance with herein described systems and methods; and

FIGS. 3-11 are exemplary block diagrams illustrating the functionality of the present invention.

### DETAILED DESCRIPTION

A computer-implemented platform and methods of use are disclosed that provide networked access to a plurality of types of digital content, including but not limited to video, audio, and document content, and that track and deliver the accessed content, such as via one or more applications, or “apps.” Described embodiments are intended to be exemplary and not limiting. As such, it is contemplated that the herein described systems and methods can be adapted to provide many types of users with access and delivery of many types of domain data, and can be extended to provide enhancements and/or additions to the exemplary services described. The invention is intended to include all such extensions. Reference will now be made in detail to various exemplary and illustrative embodiments of the present invention.

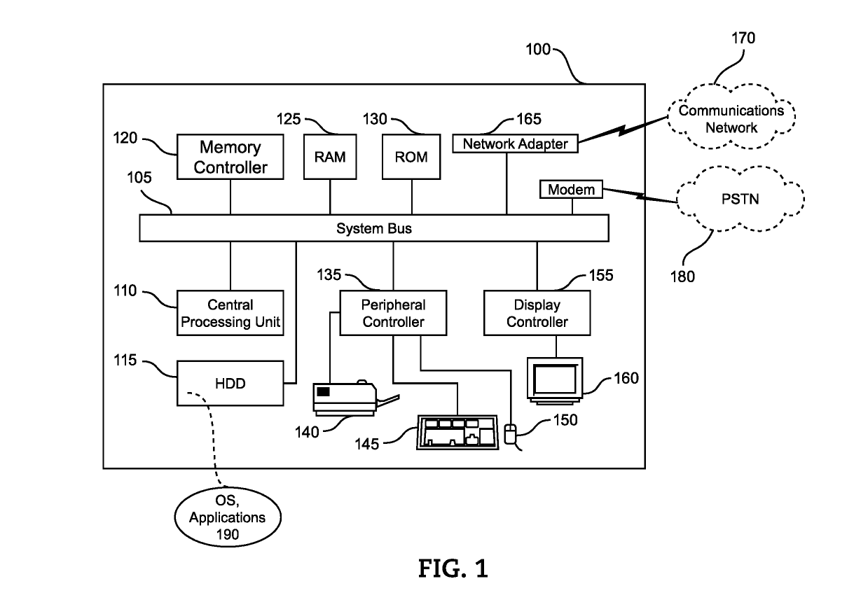

FIG. 1 depicts an exemplary computing system 100 that can be used in accordance with herein described system and methods. Computing system 100 is capable of executing software, such as an operating system (OS) and a variety of computing applications 190. The operation of exemplary computing system 100 is controlled primarily by computer readable instructions, such as instructions stored in a computer readable storage medium, such as hard disk drive (HDD) 115, optical disk (not shown) such as a CD or DVD, solid state drive (not shown) such as a USB “thumb drive,” or the like. Such instructions may be executed within central processing unit (CPU) 110 to cause computing system 100 to perform operations. In many known computer servers, workstations, personal computers, mobile devices, and the like, CPU 110 is implemented in an integrated circuit called a processor.

It is appreciated that, although exemplary computing system 100 is shown to comprise a single CPU 110, such description is merely illustrative as computing system 100 may comprise a plurality of CPUs 110. Additionally, computing system 100 may exploit the resources of remote CPUs (not shown), for example, through communications network 170 or some other data communications means.

In operation, CPU 110 fetches, decodes, and executes instructions from a computer readable storage medium such as HDD 115. Such instructions can be included in software such as an operating system (OS), executable programs, and the like. Information, such as computer instructions and other computer readable data, is transferred between components of computing system 100 via the system's main data-transfer path. The main data-transfer path may use a system bus architecture 105, although other computer architectures (not shown) can be used, such as architectures using serializers and deserializers and crossbar switches to communicate data between devices over serial communication paths. System bus 105 can include data lines for sending data, address lines for sending addresses, and control lines for sending interrupts and for operating the system bus. Some busses provide bus arbitration that regulates access to the bus by extension cards, controllers, and CPU 110. Devices that attach to the busses and arbitrate access to the bus are called bus masters. Bus master support also allows multiprocessor configurations of the busses to be created by the addition of bus master adapters containing processors and support chips.

Memory devices coupled to system bus 105 can include random access memory (RAM) 125 and read only memory (ROM) 130. Such memories include circuitry that allows information to be stored and retrieved. ROMs 130 generally contain stored data that cannot be modified. Data stored in RAM 125 can be read or changed by CPU 110 or other hardware devices. Access to RAM 125 and/or ROM 130 may be controlled by memory controller 120. Memory controller 120 may provide an address translation function that translates virtual addresses into physical addresses as instructions are executed. Memory controller 120 may also provide a memory protection function that isolates processes within the system and isolates system processes from user processes. Thus, a program running in user mode can normally access only memory mapped by its own process virtual address space; it cannot access memory within another process' virtual address space unless memory sharing between the processes has been set up.

In addition, computing system 100 may contain peripheral controller 135 responsible for communicating instructions using a peripheral bus from CPU 110 to peripherals, such as printer 140, keyboard 145, and mouse 150. An example of a peripheral bus is the Peripheral Component Interconnect (PCI) bus.

Display 160, which is controlled by display controller 155, can be used to display visual output generated by computing system 100. Such visual output may include text, graphics, animated graphics, and/or video, for example. Display 160 may be implemented with a CRT-based video display, an LCD-based display, gas plasma-based display, touch-panel, or the like. Display controller 155 includes electronic components required to generate a video signal that is sent to display 160.

Further, computing system 100 may contain network adapter 165 which may be used to couple computing system 100 to an external communication network 170, which may include or provide access to the Internet, and hence which may provide or include tracking of and access to the domain data discussed herein. Communications network 170 may provide user access to computing system 100 with means of communicating and transferring software and information electronically, and may be coupled directly to computing system 100, or indirectly to computing system 100, such as via PSTN or cellular network 180. For example, users may communicate with computing system 100 using communication means such as email, direct data connection, virtual private network (VPN), Skype or other online video conferencing services, or the like. Additionally, communications network 170 may provide for distributed processing, which involves several computers and the sharing of workloads or cooperative efforts in performing a task. It is appreciated that the network connections shown are exemplary and other means of establishing communications links between computing system 100 and remote users may be used.

It is appreciated that exemplary computing system 100 is merely illustrative of a computing environment in which the herein described systems and methods may operate and does not limit the implementation of the herein described systems and methods in computing environments having differing components and configurations, as the inventive concepts described herein may be implemented in various computing environments using various components and configurations.

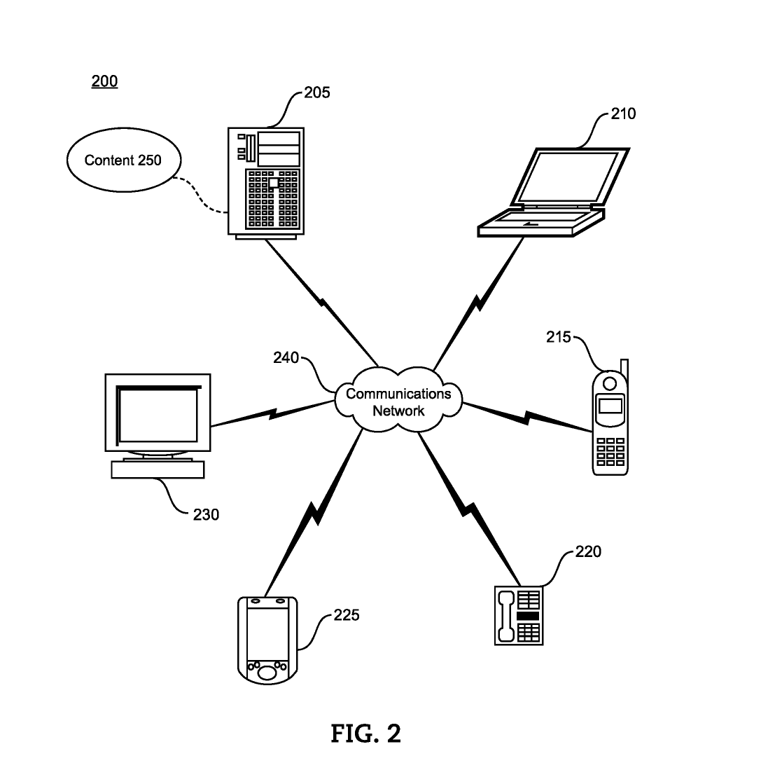

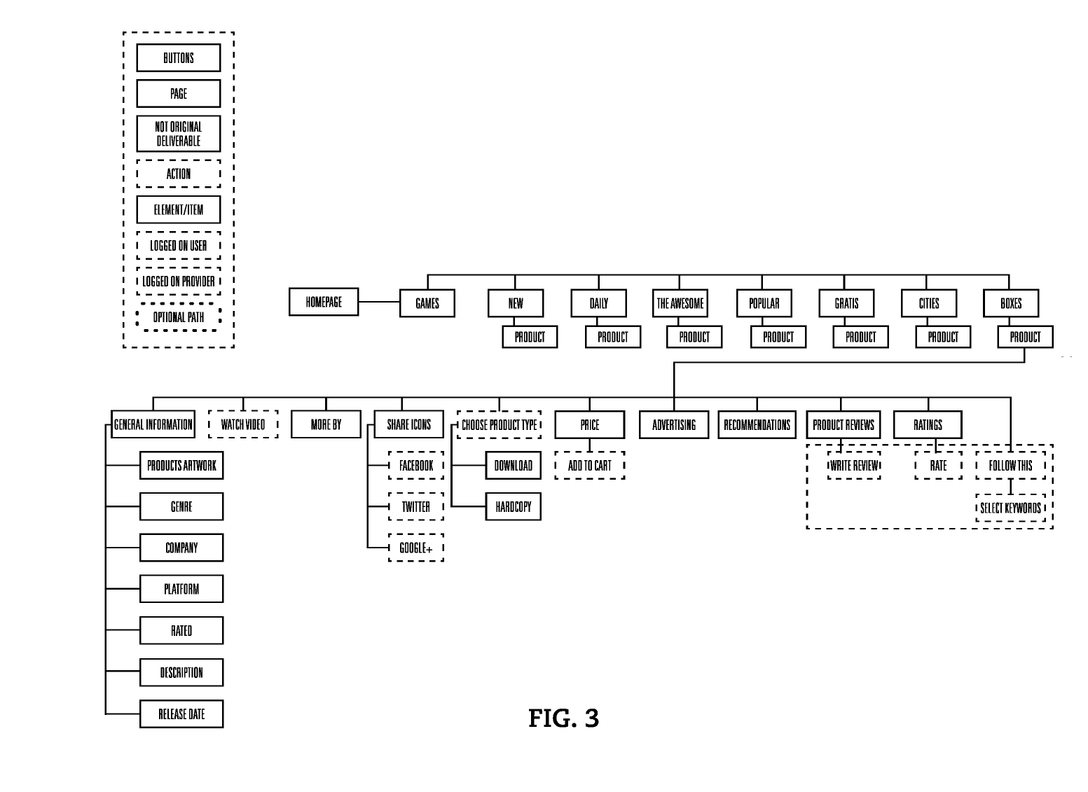

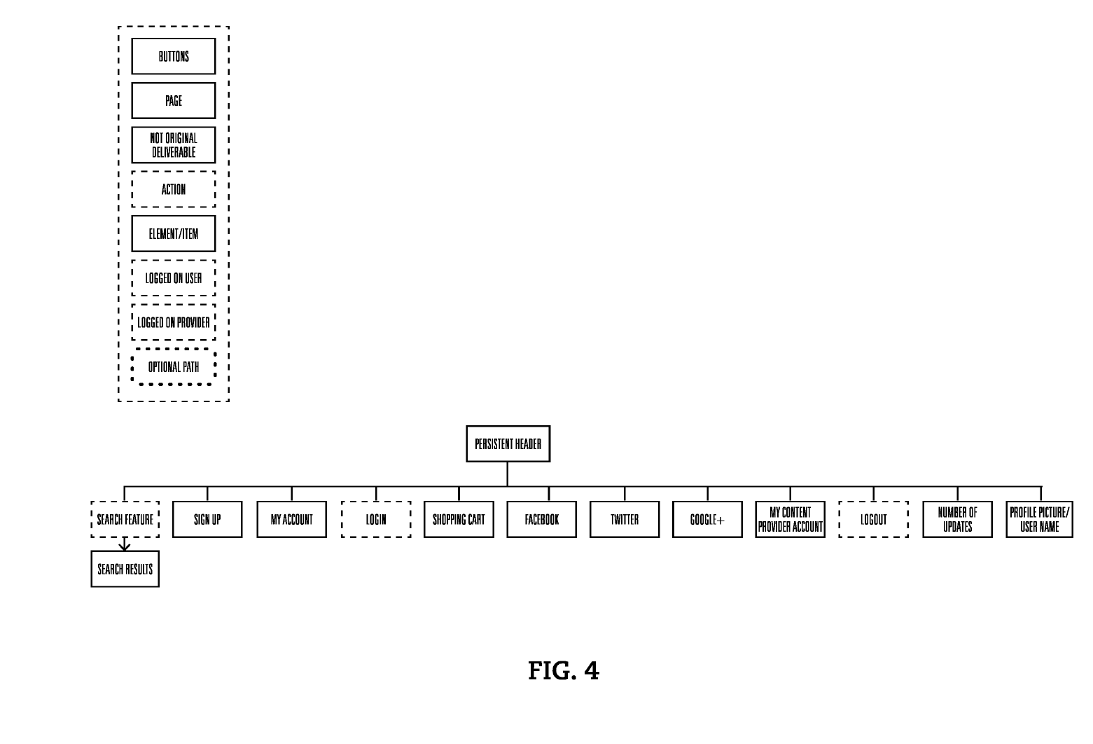

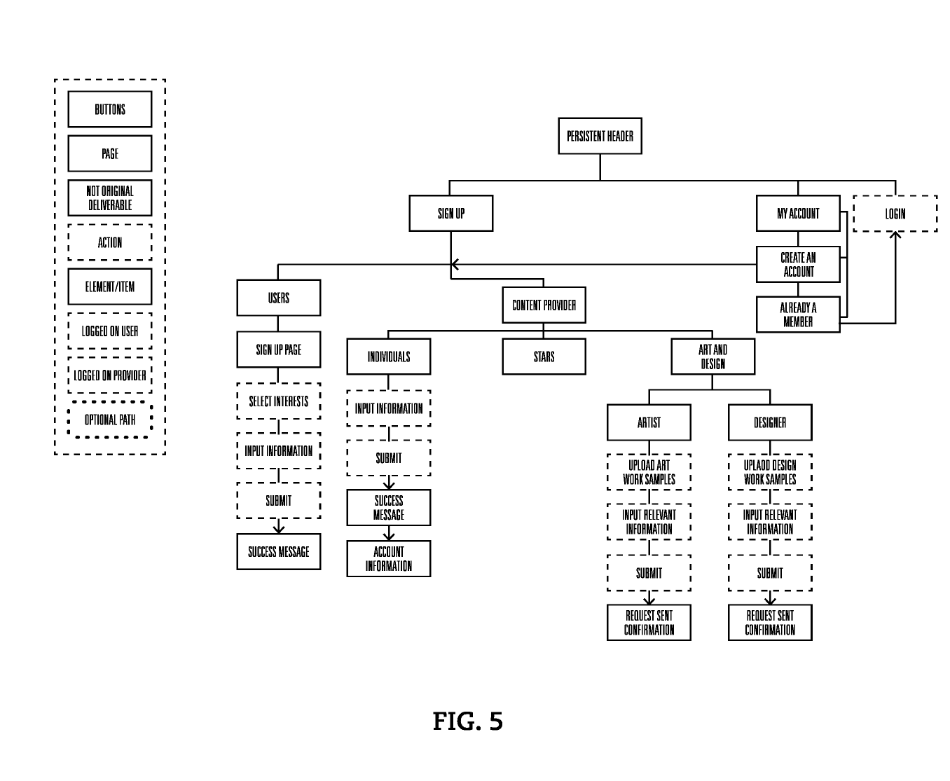

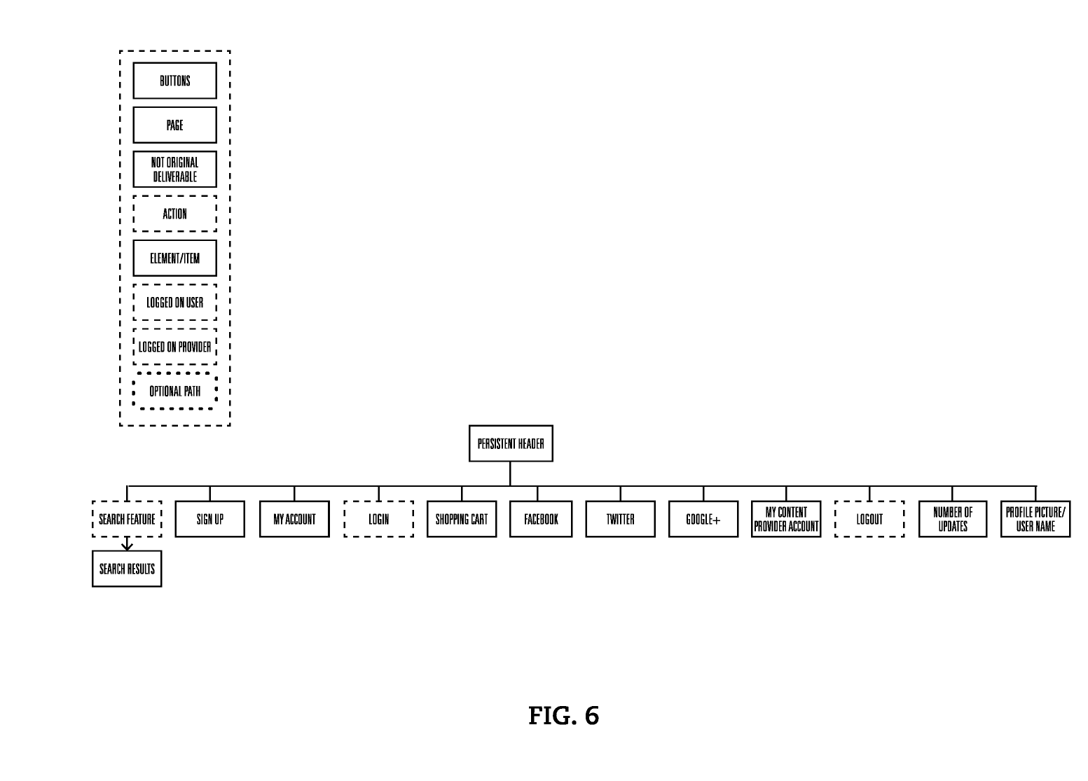

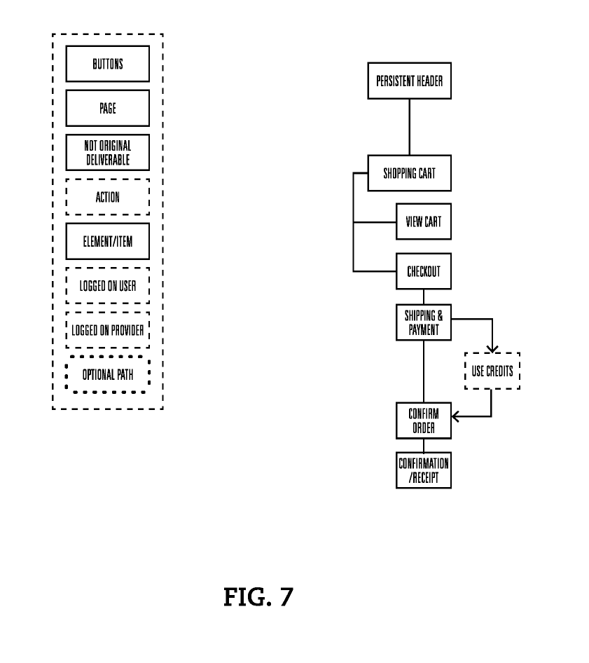

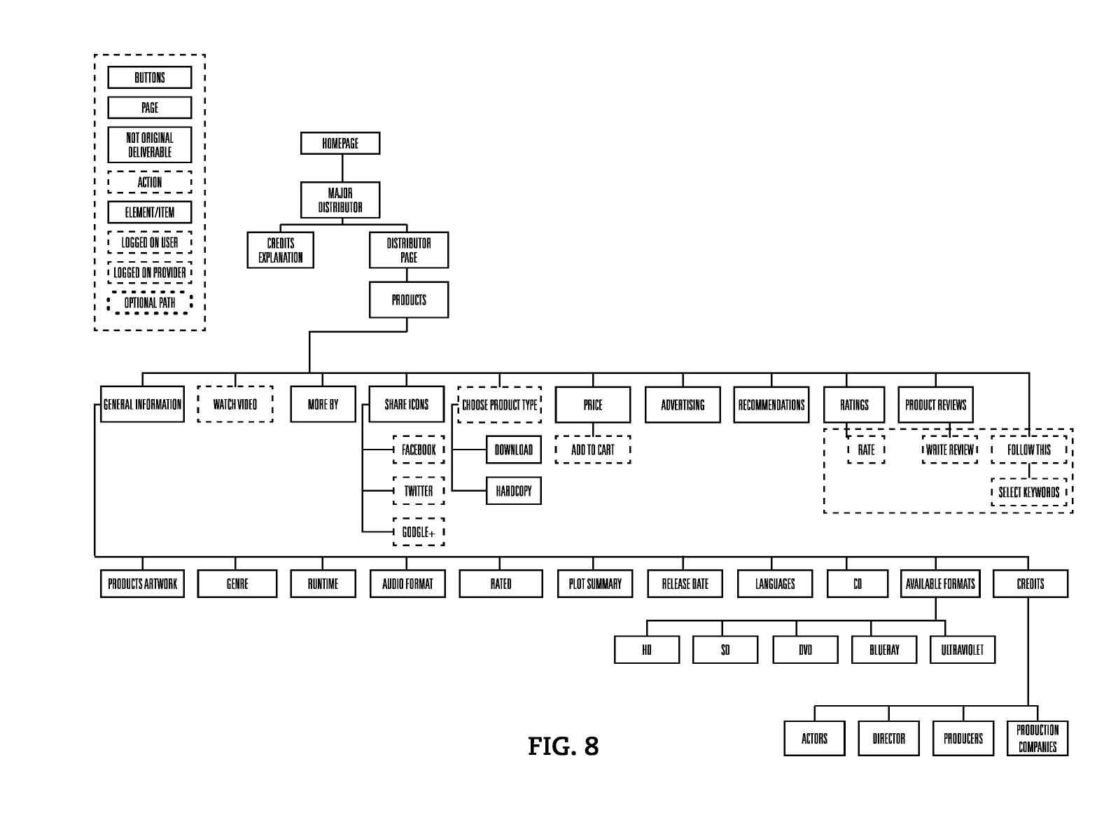

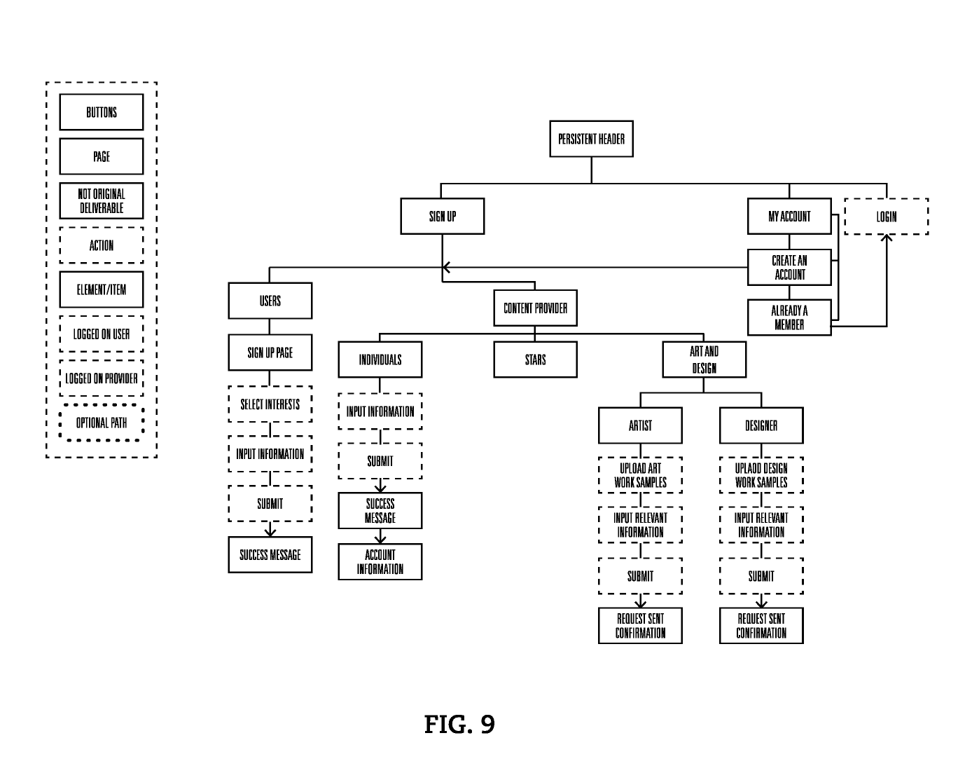

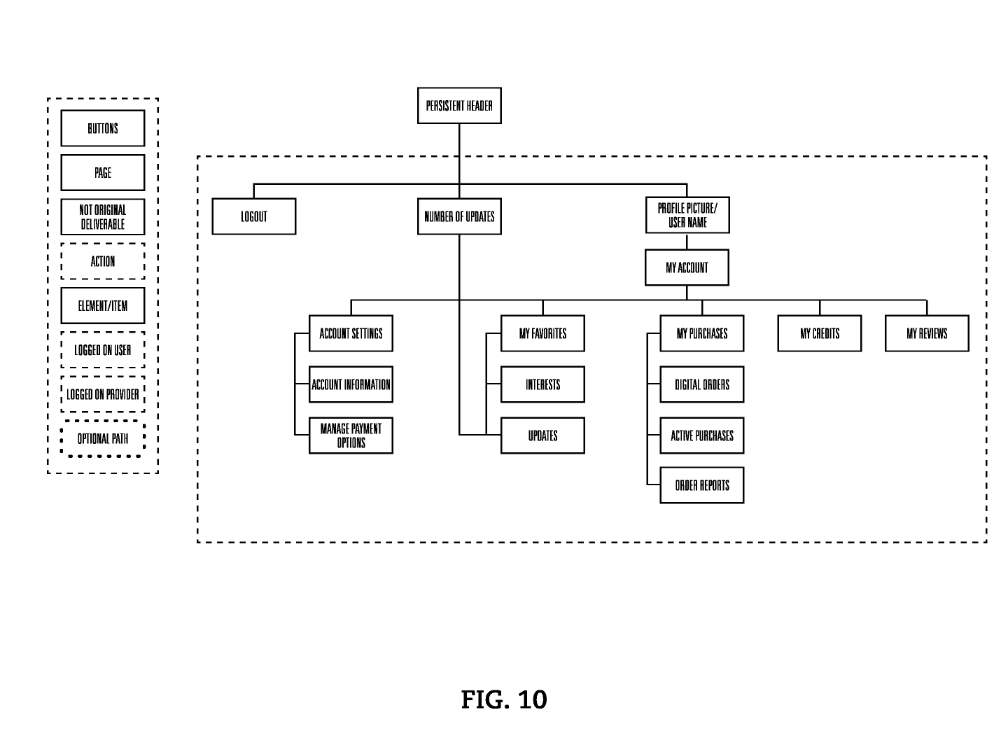

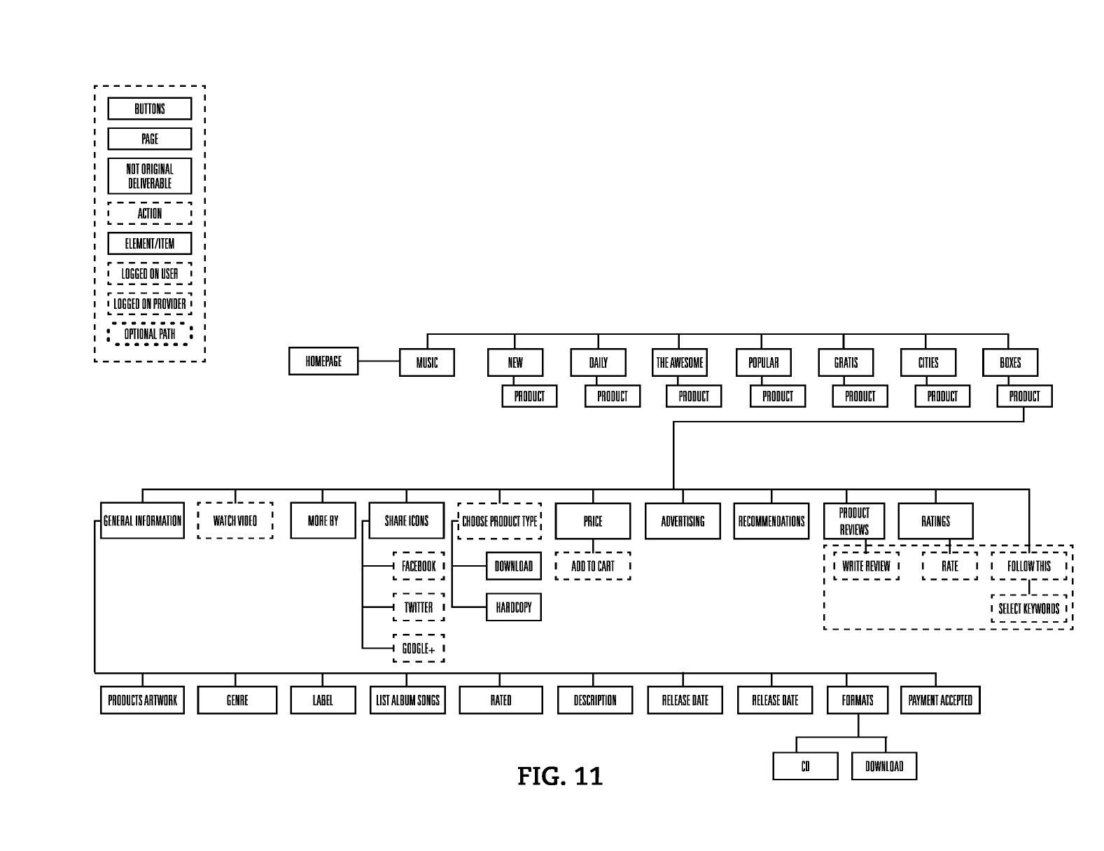

As shown in FIG. 2, computing system 100 can be deployed in networked computing environment 200. In general, the above description for computing system 100 applies to server, client, and peer computers deployed in a networked environment, for example, server 205, laptop computer 210, and desktop computer 230. FIG. 2 illustrates an exemplary illustrative networked computing environment 200, with a server in communication with client computing and/or communicating devices via a communications network, in which the herein described apparatus and methods may be employed.

As shown in FIG. 2, server 205 may be interconnected via a communications network 240 (which may include any of, or any combination of, a fixed-wire or wireless LAN, WAN, intranet, extranet, peer-to-peer network, virtual private network, the Internet, or other communications network such as POTS, ISDN, VoIP, PSTN, etc.) with a number of client computing/communication devices such as laptop computer 210, wireless mobile telephone 215, wired telephone 220, personal digital assistant 225, user desktop computer 230, and/or other communication enabled devices (not shown). Server 205 can comprise dedicated servers operable to process and communicate data such as digital content 250 to and from client devices 210, 215, 220, 225, 230, etc. using any of a number of known protocols, such as hypertext transfer protocol (HTTP), file transfer protocol (FTP), simple object access protocol (SOAP), wireless application protocol (WAP), or the like. Additionally, networked computing environment 200 can utilize various data security protocols such as secured socket layer (SSL), pretty good privacy (PGP), virtual private network (VPN) security, or the like. Each client device 210, 215, 220, 225, 230, etc. can be equipped with an operating system operable to support one or more computing and/or communication applications, such as a web browser (not shown), email (not shown), or independently developed applications, the like, to interact with server 205.

The server 205 may thus deliver applications specifically designed for mobile client devices, such as, for example, client device 225. A client device 225 may be any mobile telephone, PDA, tablet or smart phone and may have any device compatible operating system. Such operating systems may include, for example, Symbian, RIM Blackberry OS, Android, Apple iOS, Windows Phone, Palm webOS, Maemo, bada, MeeGo, Brew OS, and Linux for smartphones and tablets. Although many mobile operating systems may be programmed in C++, some may be programmed in Java and .NET, for example. Some operating systems may or may not allow for the use of a proxy server and some may or may not have on-device encryption. Of course, because many of the aforementioned operating systems are proprietary, in prior art embodiments server 205 delivered to client device 225 only those applications and that content applicable to the operating system and platform communication relevant to that client device 225 type.

JavaScript Serialized Object Notation (JSON), a lightweight, text-based, language-independent data-interchange format, is based on a subset of the JavaScript Programming Language, Standard ECMA-262, 3.sup.rd Edition, dated December 1999. JSON syntax is a text format defined with a collection of name/value pairs and an ordered list of values. JSON is very useful for sending structured data over wire (e.g., the Internet) that is lightweight and easy to parse. It is language and platform independent, but uses conventions that are familiar to C-family programming conventions. The JSON language is thus compatible with a great many operating systems (a list of such systems is available at www.json.org).

1. Up to 4 items can be in a box. They can be from the same CONTENT PROVIDER or 4 different ones.

2. Boxes have two durations: 1 DAY and 4 DAY.

3. Boxes have 4 discounts: 10%, 25%, 35% and 50%.

4. Boxes are created by the CONTENT PROVIDERS. Using the Rhovee network just for CP'S they can mark if they are open to make a box and also contact other CP'S to see if they are interested in joining a box with them.

Example: 4 Day Box at a 35% discount. Items included: Walking Dead Season 1 TV Show/Walking Dead Comics 1-10/Zombie Nation Movie/World War Z book.

All items in box would be discounted 35% and user has to buy the entire box. The Credits:

1. Only offered by major distributor who must carry a minimum amount of content on the site (determined by Rhovee) to any user of the site who has an account with Rhovee.

2. Credits may be distributed by the content provider in any amount they choose.

3. Credits issued by content providers are non-transferable.

4. Content providers may chose not to use credits as a promotional tool if they choose.

Example: HBO credits may only be used to redeem HBO products. If a user purchases a movie on HBO's page HBO may may offer 5 credits for that movie. If the user accumulates 50 credits HBO may offer a free download for one season of an HBO series.

The Updater:

1. Any user may choose to follow any content provider.

2. The user will receive updates of anything that content provider releases on their page.

3. When the user logs into Rhovee they will be able to check their updates. They can not respond back.

The Hero Bar:

1. The advertisement bar located at the top of very content page on the site.

2. It holds 6 individual ads within the bar. Three small ads are placed vertically on either side of the bar, with the center, consisting of approximately ⅔ of the space, left to highlight one of the 6 ads on a rotating schedule every 4.5 seconds.

### EXECUTIVE SUMMARY

Rhovee will be a distribution website dedicated to film/music/tv/books/comics/games/art and design. Employing a unique business model Rhovee is able to allow the content provider a significantly larger profit margin. By cross-distributing multiple categories Rhovee will attract a high volume of traffic to the site, which will benefit content providers as well as entice advertisers. An open post site, content providers will pay a monthly hosting fee to sell their products as well as be responsible for other fees such as credit card transactions and streaming charges. In exchange they will keep 100% of their profit after cost. As content providers multiply and users to the site grow so to will Advertising dollars, which is where Rhovee will make it's money.

Internet Advertising rose to $31 B during 2011. Rhovee will employ multiple forms of streaming and embedded ads over thousands of pages. This coupled with not incurring the cost of streaming and downloading fees should help to make Rhovee profitable quickly. Rhovee is set up to be Content Provider friendly. It is non-exclusive and open post. Many sites charge 30% up to 50% to sell on their site. Rhovee will never take a portion of sales and will share in the ad revenue with the Content Provider if an ad can be placed on their site.

1.1 Objectives:

1. To provide a new model for online distribution.

2. To make Rhovee a household name within the first year employing a PR firm along with celebrity endorsements and a social media campaign.

3. To build up traffic and advertising within the first year.

4. Bring attention to products sold on our site using unique cross marketing system.

5. Link with affiliates to help cross promote and strengthen our product.

1.2 Mission:

Rhovee wants to change the way distribution is set up. By making content providers simply responsible for their cost and giving control and profit back to them we create a space where they can sell for less and still make more. In doing so volume of posters and viewer traffic will increase making Rhovee a very attractive site for advertisers.

1.3 Keys to Success:

1. Distribute varied entertainment products on one site.

2. Do not pay for Content.

3. Offering Content Providers unique way to sell their products through use of video, ala Kickstarter.com.

4. Free to viewers unless they purchase.

5. Content Providers pay for streaming and fees they incur.

6. Institutes new forms of advertising unique to the site.

7. Offering Content Providers multiple opportunities to bring attention to themselves on site itself.

8. Offers two forms of profit to Content Providers—Advertising and Sales.

9. Attract key demographics for Advertisers.

10. A social media function enables users to follow any content provider on the site.

11. Simple and fun website to surf.

Structure of Site

Rhovee is set up to handle FILM/TV/MUSIC/BOOKS/COMICS/GAMES/ART/DESIGN AND MAJOR PROVIDERS (i.e STARZ/LIONSGATE/SONY MUSIC etc.). It is an open post site much like YouTube where sellers upload their product and have an opportunity to make up to a 2½ minute video to promote it and themselves. Each Poster pays a $9.99 monthly hosting fee as well as other expenses they incur such as streaming fees, credit card fees, download fees etc. After such expenses they keep 100% of their profit.

2.1 Categories on each Main Page:

1. THE NEW: New Postings are top listed here.

2. THE CHOSEN DAILY: Staff picks of their favorite projects in each category.

3. THE POPULARS: Projects that are trending or selling well.

4. THE AWESOME: Reserved for truly amazing projects.

5. THE BOXES: Posters can join together and create a package of their projects.

6. THE CITIES: Movies, music, art etc. specific to cities.

7. THE GRATIS: Posters that are offering free stuff.

2.2 Poster's Page:

1. VIDEO: 2½ minute video/trailer everyone has option to make.

2. THE BREAKDOWN: All vitals stats of what is being sold.

3. THE ART: Artwork to show off what they are selling.

4. THE SOCIAL: Links such as Facebook, Twitter, Ustream etc.

5. THE UPCOMING: Content Providers can list upcoming events or appearances. Can also list when new products are coming out.

6. THE RECOMMENDATIONS: A list of what other things users may like.

7. THE OTHER STUFF: Other works by the Film/Music/Book Publisher.

2.3 Cross Promotion:

1. THE BOXES: Up to four items can go in the box. For example: An Album/Book/Film/Comic join together and make a box with each item discounted. Example: “They set a limit at a 1000 available.” A Box symbol will go on each item that is included. If a viewer is checking out the album they can click on the box to see what else is in it, exposing them to products they may not have looked at and allowing them a deal for buying them together.

2. THE RECOMMENDATIONS: Other items a user might like will be listed on each Poster's Page.

3. THE CATEGORIES: With 7 different categories on each main page projects have multiple chances for exposure.

4. THE UPDATER: Viewers can follow their favorite artists and get immediately updated on any changes, sales or other promotions they are having.

2.4 Advertising:

1. AD BAR: Five Ads will stream across the top of every page. On the main pages the Stream will be repeated as you scroll down. Pages are only limited by the number of Posters on the site.

2. AD CELL: Branded, embedded advertising for the site. Will play in front of free videos and trailers. 7 seconds in length ads will take place within a Glass Cell. They are teasers allowing the viewer to click if they wish to see the full ad. Example: Geico Commercial—Gecko and Caveman are in Cell. Caveman looks hungry and licks his lips as he eyes the Gecko. The Gecko holds up a help sign. Click to see what happens. Enviromental Ad—Plastic bottles are piled in and breaking out of the cell. A question is typed across: HOW MANY BOTTLES ARE NOT CONTAINED AND LITTERING OUR WORLD? Click to find the answer. This creates a new and unique way of advertising that is specific to our site.

3. SPONSORED BY: 5 second Ad embedded into purchased entertainment, i.e films/shows/games.

2.5 Credits

On the Network pages they will be able to offer credits within their pages. Examples: Spend $20 get one month streaming free. Stream 6 months straight receive $10.00 off a box set and so on.

Market Analysis:

More and more people are consuming and buying their entertainment content on-line and Content Providers are looking for the best deal to sell their products. The market leaders currently are: itunes: Sell music, movies, tv shows and books. They take 30% for everything sold on their site. You must be accepted or use a third party which also takes a % to get your product on. Amazon: They take anywhere from 15% to 30% plus additional fees for everything sold on their site. They also have a movie and tv show streaming service for their Prime members. They must license and pay for the content they show as well as their streaming fees. Netflix: Streaming movie and tv service. The viewer pays $7.99 a month for unlimited viewing of their library. They must pay to license their content as well as their streaming fees. Hulu: TV and Movie streaming service. They have a free as well as a paid service (Hulu Plus). The generate revenue from ads as well as subscription. They must license and pay for their content. Pandora: Music streaming service. There is an ad based free model for the user as well as a paid subscription service. They must license and pay for their content. Comixology: Online comic book retailer. They take 50% of everything sold. With all of these services it is either not good for the Content Provider with the seller taking a large cut or their models are unsustainable without constant and robust growth. Currently Netflix—with over 22 million subscribers—does not generate enough cash to cover it's licensing and streaming fees and with offering older content like they do their growth projections for the next quarter have been downgraded.

3.1 Sales Comparisons:

All figures are per month: Content Provider(CP)

Example: The Lovely Bones by Alice Sebold
Amazon
Price: $10.19
Less 15%: $8.66
Less 0.99 c fee: $7.67
Less $1.35 closing fee: $6.32
Less 0.75 c shipping: $5.57
Profit—for CP for 100 books sold: $557.00
Profit—for Prime Member
(0.99 c waived/$40 monthly charge): $616.00
1000 Books Sold: $5,570.00
Prime Member: $6,520.00
Rhovee
Price: $10.19
Less 2.5% Credit Card: $9.94
Less 0.75 c shipping: $9.19
100 Books sold: $919.00
Profit for CP (less $9.99 hosting fee): $909.01
1000 Books Sold: $9,180.01
Pirates of the Caribbean (Streaming Rental)
Itunes
Does not assume flat fee or % paid to aggregator (Indiflix/New Video Groug/Distribber) to
get product on Itunes
Price: $4.99
Less 30%: $3.49
Profit—for CC 100 Streams: $349.00
1000 Streams: $3,490.00
5000 Streams: $17,450.00
Rhovee
Price: $4.99
Less 2.5% Credit Card: $4.94
Less 0.12 c Streaming fee: $4.82
100 Streams (less $9.99 fee): $472.01
1000 Streams: $4,810.01
5000 Streams: $22,590.01
Graphic Novel (Digital)
Comixology
Price: $7.95
Less 50% fee: $3.98
Profit—for CC 100 Sold: $398.00
500 Sold: $1,990.00
1000 Sold: $3,980.00
Kindle (option 1)
Price: $7.95
Less 30%: $5.56
Less 0.15 c fee for (24) MB: $1.96
100 Sold: $196.00
500 Sold: $980.00
1000 Sold: $1,960.00
Kindle (option 2)
Price: $7.95
Less 65%: $3.02
100 Sold: $302.00
500 Sold: $1,510.00
1000 Sold: $3,020.00
Rhovee
Price: $7.95
Less 2.5% Credit Card: $7.75
Less 0.03 c per MB (24): $7.03
Profit—100 (less $9.99 fee): $693.01
500 Sold: $3,505.01
1000 Sold: $7,020.01
Music
Per Song
Itunes
Price: $0.99
Less 30% $0.693
Profit—100 Downloads: $69.30
500 Downloads: $346.50
1000 Downloads: $693.00
Rhovee
Price: $0.99
Less 2.5 CC fee: $0.965
Less 0.5 c Download fee; $0.915
Profit—100 (less $9.99 fee): $81.51
500 Downloads: $447.51
1000 Downloads: $905.01

Strategy:

Rhovee is the first of its kind to employ an ad based revenue model to a sales website. Doing so allows a 100% of the profit after operating costs are deducted to go back to the Content Provider. By passing the costs back to the provider Rhovee's operating costs will be considerably lower then their competitors.

An engine for providing content is provided which comprises at least one processor capable of executing computing code associated with the engine a non-transitory computer readable storage medium having encoded thereon computer executable instructions for providing a graphical user interface capable of querying, remotely from said processor, a content seller for the input content information, wherein said graphical user interface provides at least a plurality of apps related to the input content information at least one network port local to said processor and capable of locally receiving the content information and interaction by the content seller with the apps from said graphical user interface at least one rules engine communicatively connected to said at least one network port and executed by said processor, and comprising a plurality of rules to generate at least a offer for sale of the content responsively to the content information and an app engine executed by said processor that provides at least an application responsive to the interaction by the content seller with the apps.

Those of skill in the art will appreciate that the herein described systems and methods are susceptible to various modifications and alternative constructions. There is no intention to limit the scope of the invention to the specific constructions described herein. Rather, the herein described systems and methods are intended to cover all modifications, alternative constructions, and equivalents falling within the scope and spirit of the invention and its equivalents.

What is claimed is:

1. An engine for providing content, comprising:
at least one processor capable of executing computing code associated with the engine;
a non-transitory computer readable storage medium having encoded thereon computer executable instructions for providing a graphical user interface capable of querying, remotely from said processor, a content seller for the input content information, wherein said graphical user interface provides at least a plurality of apps related to the input content information;
at least one network port local to said processor and capable of locally receiving the content information and interaction by the content seller with the apps from said graphical user interface;
at least one rules engine communicatively connected to said at least one network port and executed by said processor, and comprising a plurality of rules to generate at least a offer for sale of the content responsively to the content information; and
an app engine executed by said processor that provides at least an application responsive to the interaction by the content seller with the apps.
